(19) United States
(12) Patent Application Publication
(10) Pub. No.: US 2005/0114108 A1
(43) Pub. Date: May 26, 2005

(54) Safety restraint design system and methodology

(76) Inventors: John Cooper, Oxford, MI (US); Mohannad F. Murad, Troy, MI (US); Daniel Tabar, Canton, MI (US); Jason Doering, Flushing, MI (US); Hyunsok Pang, Rochester Hills, MI (US); Barney J. Bauer, Rochester, MI (US)

Correspondence Address: KEY SAFETY SYSTEMS, INC.;PATENT DEPARTMENT, 7000 NINETEEN MILE ROAD, STERLING HEIGHTS, MI, 48314, US

(21) Appl. No.: 10/963,976

(22) Filed: Oct. 13, 2004

Related U.S. Application Data
(60) Provisional application No. 60/510,931, filed on Oct. 13, 2003.

(51) Int. Cl. G06G 7/48

(52) U.S. Cl. 703/8

(57) ABSTRACT

Disclosed is a safety restraint design controller for controlling the design of a safety restraint system so that a predetermined desired level of an occupant's response is produced. The controller has a database for storing a occupant restraint factor response model. The model interrelates at least one predetermined restraint factor with the occupant response; the restraint factors having a level which is indicative of setting values for controlling the safety restraint design. A database engine connected to the database determines a level for the occupant response based upon the model and upon a first level of the restraint factors. A solver is connected to the database engine for determining a second level of the restraint factors which produces the desired level of the occupant response based upon the desired level of the occupant response from the database engine whereby the safety restraint design is controlled based upon the determined second level of the restraint factors which produces the desired level of the safety response.

### FIELD OF THE INVENTION

The present invention relates generally to the design of a safety restraint system and, more particularly, to a design methodology for the design and development of a safety restraint system for an automobile.

### BACKGROUND OF THE INVENTION

Government requirements have significantly increased the number of test scenarios under which a safety restraint system must be evaluated. To achieve these goals, a wide variety of new requirements have been added including test procedures, injury criteria, and the use of an assortment of new anthropomorphic dummies. These requirements, coupled with a shortened vehicle development cycle, significantly increase the need for improved design methodologies.

Specific injury criteria for a number of anthropomorphic dummies have been set. More specifically, head injury criteria (HIC), neck injury criteria (including tension, compression and flexion), thoracic criteria (including chest acceleration and chest deflection) and femur axial loads have been set for: hybrid III mid-sized male, hybrid III small female, hybrid III 6 year old child, hybrid III 3-year-old child, and 12 month old infant anthropomorphic dummies. For any given injury criteria value, a statistical probability of a particular injury severity can be determined. By using these injury criteria to design a restraint system, it is possible to statistically determine for a given occupant and crash situation what the likelihood of injury will be and, therefore, evaluate the effectiveness of changes to a restraint system. Prior to the incorporation of the new requirements, manufacturers were required to design air bag systems using the hybrid III mid-sized male. Due to the often complicated nature of these systems and crash events, it is often not possible to design the system for protecting all possible occupants for all possible crash situations.

Significant advancements have been made in testing methodologies and computer modeling of restraint systems. As is known in the restraint community, small modifications to the output of various restraint components often lead to significant changes in injury responses in occupants in varying crash conditions. As such, changes to the vehicle as the vehicle progresses through its development often require that changes be made to the restraint system. Using previous methodologies, this would significantly increase the amount of testing and computer simulations that must be run to verify the response of the system to changes in the vehicle structure.

Should the testing show that test results for a given occupant would fall out of acceptable government or vehicle manufacturer specifications, a significant amount of redesign and retesting would be necessary. Such recursive changes required to bring the system in compliance for one class of occupants can quickly take the response levels far away from acceptable limits for other occupants.

Engineers have performed complex design of experiments to study the interrelationships between automotive safety restraint components and occupant responses. This work has produced mathematical models that are typically very intricate, requiring three-dimensional depictions of the inner relationships.

Accordingly, modifications to the restraint factors within the design and development of a restraint system to achieve the desired occupant responses was an art form. This art form was to be learned from years of experience in controlling the restraint equipment within a vehicle. Due to these reasons, the development of a restraint system lacks the effective use of a systematic approach for controlling a restraint system, especially in view of the reduced cycle time needed in the development of an automobile.

Restraint systems, including air bag and seatbelt systems, are traditionally developed for a specific platform to meet performance requirements, incurring significant test and development costs. In addition, DV and PV's have to be completed for each unique design. In a system where the air bag performance is controlled through an algorithm, the system allows the potential of a single air bag design to be used and applied. This is a similar to the methods used by electronic suppliers for sensing diagnostic modules (SDM's). One SDM is manufactured and the control algorithm is developed to suit the specific vehicle application.

In order to maximize passenger protection during a collision, it is desirable to vary the deployment characteristics of the air bag or operating characteristics of other safety restraint components based on passenger presence and position. Specifically, it is desirable to control factors such as the inflation profile and deployment timing of the air bag depending upon the position of the passenger in a seat (i.e. whether the passenger is “in position” or “out of position”).

Vehicle crash conditions may also dictate non-deployment of the air bag. For instance, non-deployment of the air bag may be desirable if the severity of the crash is low and other safety restraint components can provide adequate protection of the passenger (e.g. the seat belt is in use and is sufficient protection in and of itself). In addition, the absence of a passenger in a vehicle seat, an out-of-position passenger, or a child in a child seat all present additional situations in which non-deployment of an air bag or modified deployment is desirable.

It has been shown that an occupant's position can be determined to a limited extent with the use of a single position sensor. The use of a single proximity sensor in order to determine occupant position and presence has several disadvantages. For example, while a single proximity sensor located in the instrument panel (IP) may indicate the distance of an object from the IP, the single sensor cannot distinguish whether a small object (i.e. a hand) is close to the IP or if the torso of the occupant is near the IP. The location of the occupant's torso, as opposed to identification of an “object's” position within a sensor field is advantageous in determining the actions of a vehicle restraint system during a collision.

Developments in the restraint field have increased the ability to track occupants within the vehicle as well as modify the output of various restraint components. What is needed is a design methodology and a restraint system that overcome the disadvantages of the prior art.

### SUMMARY OF THE INVENTION

As such, a computer implemented method for designing a safety restraint system so that a predetermined desired level of occupant responses is produced is disclosed. This method includes the steps of storing an occupant restraint factor response model in a computer storage media. The model relates at least one predetermined restraint factor having a level, which is indicative of an output for components within the design of the restraint system, with an occupant's response. The methodology determines the level of an occupant's response based upon the model and upon a first level of restraint factors. The model then determines a second level of the restraint factors, which produces the desired level of the occupant's response based upon the determined level of restraint factors. In addition, the system modifies the restraint system based upon the determined second level of the restraint factors to produce the desired level of the occupant response. This modification utilizes interface techniques to couple the occupant restraint factor model to an external solver module to adjust and optimize the parameters of the restraint system.

Further disclosed is a computer implemented method for controlling the design of an occupant restraint system so that a predetermined desired level of occupant responses is produced. The system stores an occupant restraint factor response model in a computer storage media. The model relates at least one predetermined restraint factor with the occupant response, the restraint factors having a level which is indicative of setting various values for controlling the design of the restraint system. Next, the system establishes at least one constant for the model, based upon the desired value of the vehicle occupant's response. Next, the system determines the required levels of the of the restraint factors, which produce the required parameters, based upon the model having the established constraint. Finally, the system controls the design of the occupant restraint system by defining the required response of the restraint components. This allows the system to assist in the design of a real-time restraint system.

In view of the foregoing, it is an object of the present invention to provide a system and methodology that accurately determines occupant presence and position for a vehicle safety restraint system. This data is subsequently utilized to control the dynamic performance in real-time of various safety restraint components in the vehicle. The actions of these safety restraint components may be controlled in accordance with the occupant's seating position and changed in response to changes in the severity of an accident in order to maximize passenger protection in a vehicle collision. Additional advantages and features of the present invention will become apparent from the subsequent description and appended claims, taken in conjunction with the accompanying drawings.

In accordance with the teachings of the present invention, an occupant sensing apparatus for controlling operating characteristics of a vehicle's safety restraint system is provided. The apparatus has a first sensor coupled to a vehicle's seat belt retractor which outputs a signal indicative of the relative position of the occupant within the vehicle. A controller configured to modify the output of various restraint components within a predetermined time period receives the first output signal and generates a control signal that is used to control the operating characteristics of the vehicle's safety restraint system. The system utilizes open loop methodologies (no feedback) with real-time control applied to the restraint system actuators. Occupant response is not directly measured.

In one embodiment of the invention, the system is configured to measure an output indicative of occupant response (i.e. seat belt force) and then adjust restraint level. The controller then uses closed loop methodologies (with feedback) with real-time control applied to the restraint system actuators. Occupant response is continuously monitored through a sensor that is monitoring a response that relates to the occupant energy or force, i.e. seat belt force.

In yet another embodiment of the invention, the system is configured to measure occupant response directly and then adjust restraint. The controller utilizes closed loop methodologies (with feedback) with real-time control applied to the restraint system actuators. Occupant response is continuously monitored through a sensor that is monitoring the response of the occupant, i.e. chest acceleration.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Still other advantages of the present invention will become apparent to those skilled in the art after reading the following specification and by reference to the drawings in which:

FIG. 1 is a schematic representation of the interface between the occupant restraint factor model and the external solver;

FIG. 2 is a schematic representation of the design system, including coupling module;

FIG. 3 is a schematic representation showing the interaction between the occupant restraint model and either simulated or real word data through the control algorithm;

FIG. 4 is a vehicle restraint system including an occupant position sensing apparatus of an embodiment of the present invention;

FIG. 5 is a flowchart illustrating the operation of the vehicle safety restraint system;

FIG. 6 is a chart representing the actuation of the system described in FIG. 5; and

FIGS. 7a-7d represent an actuatable housing vent according to the teachings of the system of FIG. 4.

### DETAILED DESCRIPTION OF THE PREFERRED EMBODIMENTS

The following description of the preferred embodiment concerning the design and development of a safety restraint system is exemplary in nature and is not intended to limit the invention or its application or uses. Moreover, while the present invention is described in detail below generally with respect to a vehicle air bag and seat belt system, it will be appreciated by those skilled in the art that the invention is clearly not limited to attachment only to these components may be applied to various other structures which have an actuatable safety restraint device, as further discussed herein.

A development system 10 and methodology uses a software package 12 that allows the development of active control algorithms 14 used to control occupant restraint performance 16, and further allows for the development of a real-time vehicle restraint system 18. The development system 10 allows for the testing of an active control algorithm 14 applied to components 20 within the vehicle restraint system 18. The development system 10 allows for the outline and definition of sensor 21 and restraint actuator 25 hardware specifications for real-time closed loop restraint systems. In this regard, sensors 21, algorithm 14, and restraint components 20 can be simulated and evaluated virtually to determine if they can function as a working system under varying situations.

Additionally, the development system 10 allows for the numerical testing of actual hardware used in a real-time or quasi-realtime adjustable restraint system. The development system 10 uses a recursive automated multi-domain restraint simulation code to evaluate, adjust, and optimize the response of a restraint system 18 under various crash situations. This methodology reduces time, effort, and cost to obtain validation of a particular system configuration. The development system 10 uses a software package and methods to interface and link a multi-domain restraint simulation code or model 22 which models, simulates, and analyzes dynamic a crash event with a separate mathematical solver 24. An interface software package 26 integrates the multi-domain restraint simulation code 22 with a mathematical solver 24, which provides an extensive range of analysis and design tools.

The multi-domain restraint simulation code 22 contains a simulation model 28, stored within a computer's storage medium which describes a vehicle having at least one occupant. The model 28 simulates a crash event by conducting a series of calculations which describe the event over a discrete time domain. The model 28 describes a plurality of restraint components 30, occupants 32, as well as a vehicle 34. Additionally, the model 28 is configured to simulate a crash event by simulating the application of crash forces to the vehicle 34. The restraint components 30 can either be active such as an actuatable seatbelt of air bag system, or can be passive such as interior trim components. Further, it is envisioned that the active restraint components 30 can have varying outputs which can vary depending on a number of variables such as the occupant's weight, position, or vehicle speed. It is envisioned that the outputs of the restraint components can be actuated and modified in real-time.

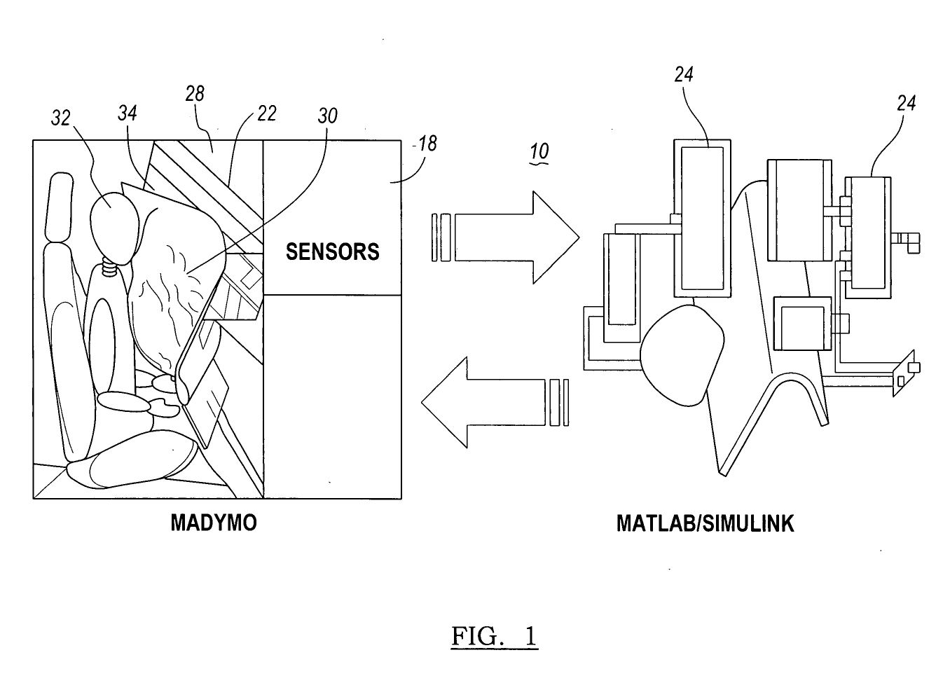

The multi-domain restraint simulation code 22, which is preferably a MADYMO™ model, is configured to interface with the solver 24 at predetermined intervals of the simulation time steps. The solver 24 is preferably MATLAB/SIMULINK™. As in FIG. 1, the solver 24 receives inputs from sensors through the interface software 26 within the multi-domain restraint simulation code 22. After a predetermined number of time steps, the solver 24 processes the data through a simulated control algorithm 14, and generates the appropriate restraint control signals that are then passed back to multi-domain restraint simulation code 22. In this regard, it is envisioned the solver 24 can receive inputs each time step. The multi-domain restraint simulation code 22 in turn uses the control signals to adjust parameters of the restraint system 18 through a range of actuators. The multi-domain restraint simulation code 22 then regenerates new input signals from the sensors 21 and passes the new data back to solver 14.

The control algorithm 14 resides within the solver 24 and processes all the sensor inputs and generates actuation signals to control the restraint system within multi-domain restraint simulation code 22. For example, the actuation signals can be used to actuate an air bag, seatbelt, knee bolster, or column stroke. This allows the acceleration of the occupant's head, chest, knees, etc. to be kept below some desired pre-defined threshold level. Additionally, the solver 24 can contain an optimization routine which is configured to restrict the variation of the response of the system restraint components within permissible level ranges. The solver determines a second level of restraint factors after receiving inputs from the occupant response storage model. The model interrelates at least one restraint factor with at least one occupant response level.

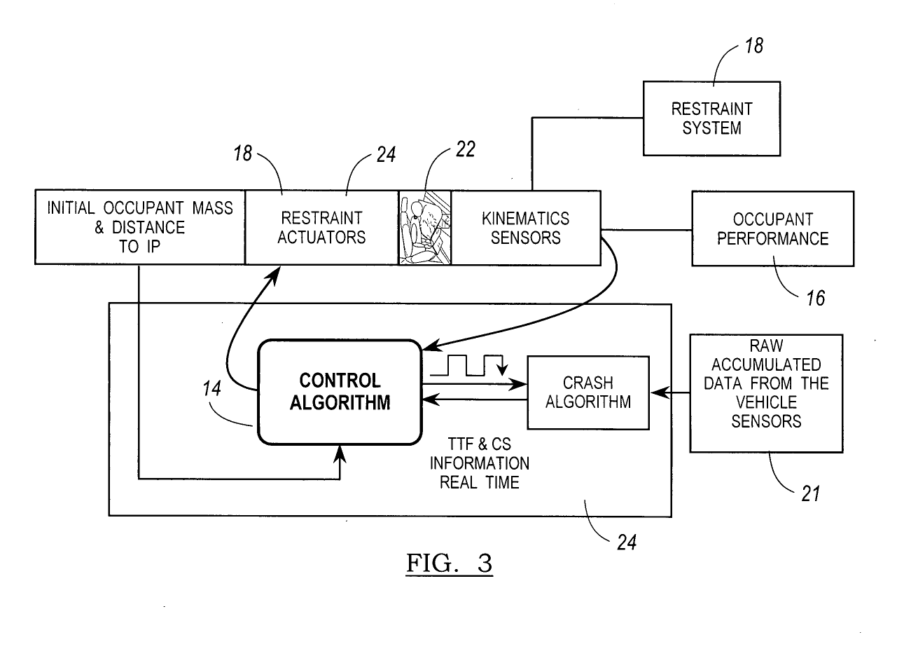

As shown in FIG. 3, the control algorithm inputs such as crash severity, time to fire, occupant size or position, applied forces of various body regions, can be either ideal signals that come from sensors placed within the multi-domain restraint simulation code model or real signals from real hardware such as an accelerometer or an ultrasound position sensor passed directly to the solver 24.

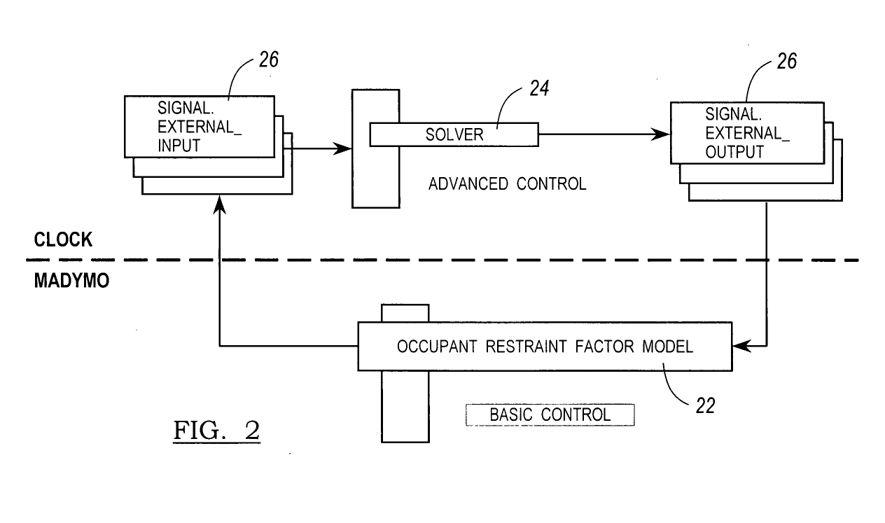

The development system 10 also allows interaction with the vehicle crash algorithm 14 either as a look up table for a given time step, or with the crash algorithm running simultaneously and communicating at the end of each time step as shown in FIG. 2. In this way, either open or closed loop crash algorithms 14 can be developed to enhance the occupant performance in a virtual way independent of the actual vehicle.

For example, in the simulation of a given crash event, the crash algorithm 14 can detect the initial crash severity and instruct the restraint system to implement a specific control strategy. As the crash evolves, the algorithm 14 can detect changes in the severity producing a change in the required control strategy. This strategy in the form of potential restraint regime can be modified and can be communicated to the any of the multi-domain restraint simulation code, the interface, or the solver software modules. This produces a development environment where the crash algorithm and the restraint control algorithm can be developed simultaneously, using a virtual method. Particularly, the timing and variables and the organization of control loops of the occupant protection control algorithm.

The development system 10 allows the components (air bag, seatbelt, etc.) to be developed at a component subsystem level and then tuned at a full system level (vehicle level) to achieve the desired performance. With the real-time restraint control of the restraint system, a component specification could be generated and given to supplier for multiple components including seatbelt and air bags. The supplier of restraint components or sensors then develops the component to meet the specification independently of the vehicle. Once the component or sub system is ready, it can be introduced into the vehicle environment and the restraint performance tuning is completed through modification control algorithm 14.

The development system 10 allows the development of a crash and restraint control algorithms 14 in a virtual environment. The development system 10 transforms restraint performance from a hardware focus to an algorithm 14 and software focus, therefore reducing the time and cost while increasing restraint performance. It allows the restraint system to be developed to provide higher levels of protection across a wider range of field crashes using off the shelf hardware components.

The above methodology lends itself to a full vehicle development using virtual methods. In the early stages of vehicle development, using the development method the specification of product requirements can be defined to meet a range of conditions. Total vehicle performance can then be continuously improved through the development of the control algorithm along with minor changes to the restraint components. Input and calibration information required to develop the control algorithm development is initially obtained from a virtual environment and then further developed to a high level by inputting real world sensors data or outputs to the solver inputs in the same environment. This allows the restraint system 18 to be developed independently of the vehicle lending itself to virtual design methods.

The occupant protection control algorithm 14 optionally allows real-time control of the restraint system using occupant weight, age and or medical condition, seat track position, occupant to vehicle position (head to IP), belt load, belt status, vehicle crash pulse, pre crash input as sensing inputs into an occupant control module (OCM). The OCM may or may not be embedded in the SDM, with active control enabled by variable venting, seat belt load actuation.

The development system 10 develops the factors of the occupant protection control algorithm 14 which maximizes the initial total restraint of the occupant at crash onset through real-time controllable restraint products (i.e. pre-tensioner, column position and stiffness, vent, knee restraint, initial load limiter setting), and then optimizes the load limiting throughout the crash event by minimizing occupant head and chest injury. In a crash event, an unrestrained occupant is more susceptible to contacting the interior parts of the vehicle (such as the instrument panel) due to the deceleration event of the vehicle. This usually results in the occupant injury values reaching their maximum levels.

The optimal case would be to take advantage of the distance between the occupant and the interior surface of the vehicle and use that to control the occupant motion during the deceleration event. In order to achieve this, it is important to minimize the occupant displacement between the crash onset and deployment of the full restraint system. This can be achieved by maximizing the initial restraint of the occupant at crash onset through seat belt pre-tensioning, seat belt locking, maximum air bag output with zero venting, etc. without endangering out of position occupants. For each crash type and severity, a pre-determined vehicle deceleration threshold is calculated. The development system 10 pre-defines a series of occupant injury thresholds. Once the occupant injury threshold levels are exceeded, the restraint system is automatically adjusted through vent opening, belt payout and load limiting, etc. to minimize occupant injuries.

The development system 10 controls the chest and head acceleration through monitoring of the vehicle deceleration pulse subsequently using the vehicle deceleration as a control input for the real-time control algorithm 14. In this case, the development system 10 allows for a crash algorithm 14 to continuously monitor for the vehicle crash pulse type, severity, and duration. The development system 10 uses the inputs from the solver 24 through the interface software 26 to define a series thresholds for varying impact event types. Based on the analysis of the crash pulse data, various control schemes can be selected and applied. This approach can be used with an open loop type controller. For example, in the early stages of a crash, the energy conditions indicate a frontal 25 mph condition and the controller selects the appropriate control settings (e.g. for belt and venting of the air bag). Then, in the later stages of the crash, the energy conditions more closely resemble a 35 mph impact and the control settings are subsequently modified to suit the new crash conditions. In this case, the occupant response is not measured and there is no feed back to the control algorithm. This reduces the potential error in defining the crash severity and identifying the restraint control because more time can be used to 100% qualify the crash severity.

The development system 10 uses the model 22 to predict the occupant position through initial seat position and belt payout status. It further uses the real-time seat belt force as a chest acceleration sensor input for the real-time control algorithm. In this case, the level and rate of change of the belt force infers the chest acceleration. The belt force is then used in the control algorithm (biomechanical) and real-time adjustments are then made accordingly. The development system 10 recursively uses the occupant restraint factor code 22 in the development of active control algorithms 14 used to control occupant restraint performance 16, and further allows for the development of a real-time vehicle restraint system 18.

In this regard, the development system 10 optionally can set configure restraint system to use the real-time air bag pressure as a head acceleration sensor input for the real-time control algorithm 14. For example, the level of air bag pressure infers the head acceleration. The air bag pressure is then used in the control algorithm (biomechanical) and real-time adjustments are then made accordingly. The air bag pressure is measured using sensors placed within the air bag modules housing.

The development system 10 additionally is further configured to set the parameters/variables of the restraint system to adjust the belt stiffness once a desired chest acceleration and/or belt load threshold is exceeded, maximizing the ride down space while minimizing the chest and head injury. The belt stiffness is continuously adjusted real-time after a threshold condition has been reached. If the chest acceleration increases above the threshold condition, the stiffness of the belt is reduced. If the belt force falls below the threshold, the belt force is increased. With this method the chest G injury is minimized and the ride down space within the vehicle is utilized to a maximum. The restraint system controls the maximum seat belt load limiter displacement or belt payout minimizing potential of contact with injurious surfaces. It is possible, in a severe crash condition with limited ride down space, the occupant could make contact with the interior. To reduce the probability of contact, the belt payout and/or load limiter displacement is monitored and controlled. Based on vehicle interior space defined in the multi-domain restraint simulation code 22, the maximum load limiter displacement is set. The maximum load limiter displacement is dependent upon the initial payout condition and position of the seat. A sensor mounted in the retractor monitors the pay out of the belt and the control system, in conjunction with the seat position data, would decide if the occupant were at risk of contacting the interior. Examples of this can be found in commonly assigned U.S. Pat. No. 6,598,821; U.S. Pat. No. 6,439,494, and U.S. patent application Ser. No. 10/135,566, herein incorporated by reference.

Additionally, the development system 10 allows the restraint system 18 to utilize occupant proximity sensing systems and data to control the seat belt load and displacement performance in real-time. In addition to monitoring the belt payout and load limiter displacement, the proximity of the head and chest is monitored through a proximity sensing system and the data is fed back to the restraint control algorithm. For example, if the head and chest are too close to a contact surface the seat belt and air bag are stiffened to minimize contact potential. It is envisioned this tightening can be accomplished using pretensioner or appropriate actuators coupled to the retractor. It is envisioned that the system 10 can develop independent control algorithms (driver and passenger) for the occupant's restraint system 18 based on independent sensor inputs and real-time deceleration data.

During an offset type crash condition, the impact energy seen by each frontal occupant can vary with seat position. The development system 10 allows the development of a real-time control device to provide the appropriate restraint to each occupant dependent upon the related impact conditions as seen by that occupant. The development system 10 allows for the adjustment of the restraint performance to be tailored to unique real world events of the specific crash. Real-time controls adjust the restraint system 18 to control the head and chest accelerations to pre-defined threshold levels. If the levels are exceeded, the restraint system changes appropriately. In this way, the restraint control is directly matched to the actual crash and provides a unique restraint control for each specific crash.

The development system 10 allows for the development of a restraint control to be applied to multiple impacts through real-time control of restraint parameters. The real-time control of the restraint system allows for monitoring the occupant performance and can, therefore, be used in multiple impact conditions. In the case of the seat belt system, the first impact may not be severe and the belt force is controlled accordingly. The second or later impact may then be severe and an appropriate restraint level is supplied based on the new impact and occupant conditions, subsequently providing the appropriate restraint over a series of impacts. As a result, the opportunity to provide improved restraint over a range of conditions increases.

The following description of the preferred embodiments is merely exemplary in nature and is in no way intended to limit the invention, its application, or uses.

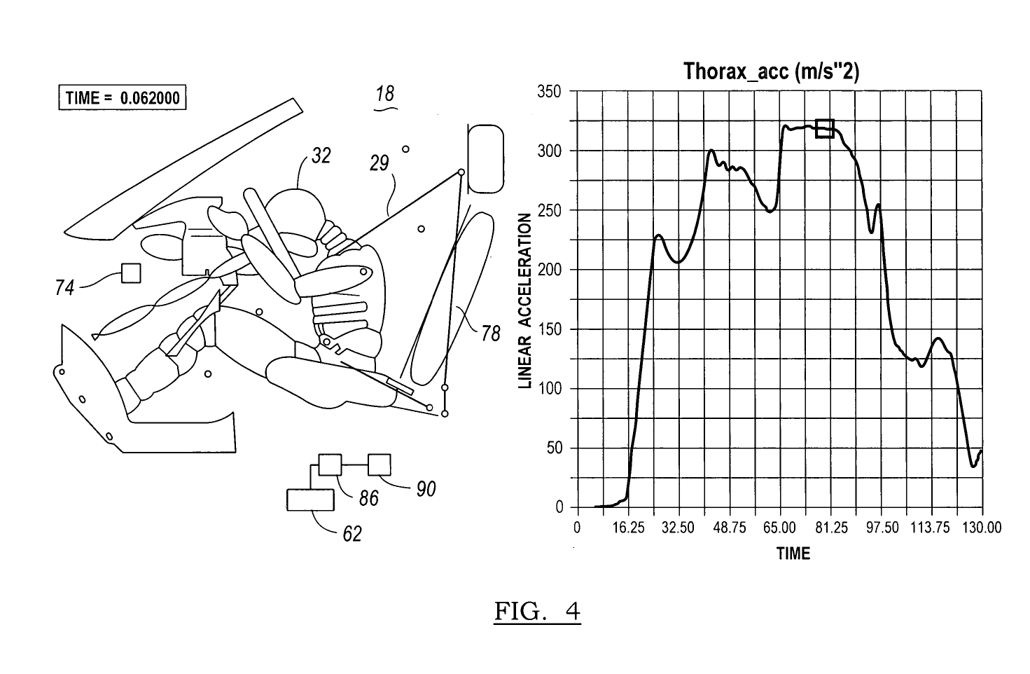

FIG. 4 shows a side view of a typical vehicle passenger compartment 26 having an occupant presence and position sensing apparatus in accordance with a preferred embodiment of the present invention that will be used to control the operating characteristics of the vehicle's safety restraint system. The vehicle safety restraint system includes a retractor 27 about which a seat belt 29 is wound, pretensioner or belt tightener 33 associated with either the retractor or buckle, and pretensioner squib 31 (which activates the pretensioner) for seat belt 29 control, and an air bag assembly 30 mounted in a dashboard or instrument panel 35 of the compartment 26.

The air bag assembly 30 has an air bag 38 that is folded and stored within the interior of an air bag housing 42. A deployment door 46 covers the air bag 38 and is configured to open upon inflation of the air bag 38. The door 46 can be part of the instrument panel or separate therefrom.

A first gas source 48 and second gas source 50 are mounted at the back of the housing 42 and operatively connected to the air bag 38. Gas from the first and/or second gas source 48, 50 is provided to the air bag 38 such that the air bag 38 is filled to an inflated condition. Once inflated in response to an impact event, the air bag 38 cushions an occupant positioned in the passenger compartment 26.

The gas sources 48, 50 typically have electrically actuated ignitors, referred to as squibs. A first squib 52 and second squib 54, when activated, actuate the first and/or second gas sources 48, 50 to produce or release inflation gas. The squibs 52, 54 may be singularly activated, simultaneously activated, or activated in staged sequence to control the rate or degree of air bag 38 deployment as desired.

An electrically controlled vent valve 58 is also connected to the air bag assembly 30 such that when the vent valve 58 is electrically opened, a certain amount of gas from the gas sources 48, 50 is vented to the atmosphere, thereby decreasing the amount of gas entering the air bag 38 and providing additional air bag inflation control.

The squibs 52, 54, vent valve 58, retractor 27 and/or buckle pretensioner 33 (via the pretensioner squib 31) are electrically activated by a controller 62, such as a microcomputer, when a crash event is sensed. The controller 62 provides the necessary signals such that the appropriate dynamic inflation profile of the air bag is produced and the seat belt action is tuned for particular crash conditions and the presence and/or position of the vehicle occupant.

FIG. 5 presents an overview of the steps performed by the safety restraint system during an execution cycle of the controller 62. Initially, the controller gathers the signals from occupant presence sensors in the instrument panel (IP), seat, and seat position sensor. Once these signals are obtained, the seating profile of the occupant is identified using the gathered data as will be subsequently described in further detail. The system the determines the distance to the instrument panel.

Once the seating profile is identified, the system commonly poles the sensors to determine if the occupant has reached a position within the vehicle compartment which may indicate an increased risk of injury. Such a location would be presented in situations where a seat occupant places a limb (i.e. feet or hand(s)) on the dashboard while remaining seated. However, if a determination is made that the sensors indicate that a standard occupant profile exists, the system calculated the time it will take the occupant to reach the Instrument panel for a number of crash senarios.

If the data is determined to be within the range of possible positions, the identified position is added to a rotating storage queue that stores the most recent positions. If the current position is considered to be unreliable, a weighted average may be used as the current position of the occupant or alternatively, a previous position that was considered to be reliable may be used.

Once the occupant position has been determined and this measurement has been verified, the system gathers information from crash sensors 66 that may include an accelerometer and/or a crash tube. With the crash sensor information, a determination is made as to whether or not a crash has occurred. If a collision condition does exist, the severity of the impact is calculated from the crash sensor inputs. Once the severity has been determined, the system determines possible desired injury thresholds for a particular occupant and crash scenario. The system also determines potential restraint component outputs. Once the severity has been determined, this factor is utilized along with the position data in order to calculate the response of each individual restraint component. Based upon these calculated restraint responses, the system triggers the restraint components to maximize passenger protection .

Maximum initial passenger protection is available from this safety restraint system due to an accurate determination of occupant presence and position. The controller receives presence and position information from the occupant presence and position sensing devices or estimates potential occupant response based on seat belt tension or airbag pressure. The system determines if the restraint level is maximized. If the restraint level is maximize, but the calculated response is below the threshold level, the system continues. Should the system determine that the calculated response is about the desired threshold, the system adjusts the parameters of the restraint system to change lower the calculated occupant response. The occupant presence and position sensing devices may include a first proximity sensor 70 located in the front portion of the instrument panel 35, a second proximity sensor 74 mounted in the seat back 78, and a seat position sensor 76 mounted to the seat position track 80. A first interface circuit 86 and second interface circuit 90 condition the output signals produced by the first and second proximity sensors 70, 74.

The occupant protection control algorithm 14 allows real-time control of the restraint system using occupant weight, age and or medical condition, seat track position, occupant to vehicle position (head to IP), belt load, belt status, vehicle crash pulse, pre crash input as sensing inputs into an occupant control module. The occupant control module may or may not be embedded in the SDM, with active control enabled by variable venting, seat belt load actuation.

The factors of the occupant protection control algorithm 14 which maximizes the initial total restraint of the occupant at crash onset through real-time controllable restraint products (i.e. pre-tensioner, column position and stiffness, vent, knee restraint, initial load limiter setting) and then optimizes the load limiting throughout the crash event by minimizing occupant head and chest injury. In a crash event, an unrestrained occupant is more susceptible to contacting the interior parts of the vehicle (such as the instrument panel) due to the deceleration event of the vehicle. This usually results in the occupant injury values reaching their maximum levels.

During the crash event, the system continues to monitor the vehicle crash sensors and occupant position sensors. The system takes advantage of the distance between the occupant and the interior surface of the vehicle and use that to control the occupant motion during the deceleration event. In order to achieve this, it is important to minimize the occupant displacement between the crash onset and deployment of the full restraint system. This can be achieved by maximizing the initial restraint of the occupant at crash onset through seat belt pre-tensioning, seat belt locking, maximum air bag output with zero venting, etc. without endangering out of position occupants. For each crash type and severity, a pre-determined vehicle deceleration threshold is calculated. The occupant control module 62 either predicts or measures a series of occupant injury thresholds throughout a crash event. Once the occupant injury threshold levels are exceeded, the restraint system is automatically adjusted through vent opening, belt payout and load limiting, etc. to minimize occupant injuries.

The occupant control module 62 controls the chest and head acceleration by monitoring of the vehicle deceleration pulse subsequently using the vehicle deceleration as a control input for the real-time control algorithm 14. In this case, the occupant control module 62 allows for the crash algorithm 14 to continuously monitor for the vehicle crash pulse type, severity, and duration. The occupant control module 62 has an associated series of thresholds for varying impact event types. Based on the analysis of the crash pulse data, various control schemes can be selected and applied. This approach can be used with an open loop type controller. For example, in the early stages of a crash, the energy conditions indicate a frontal 25 mph condition and the controller selects the appropriate control settings (e.g. for belt and venting of the air bag). Then, in the later stages of the crash, the energy conditions more closely resemble a 35 mph impact and the control settings are subsequently modified to suit the new crash conditions. In this case, the occupant response is not measured and there is no feed back to the control algorithm 14. This reduces the potential error in defining the crash severity and identifying the restraint control because more time can be used to 100% qualify the crash severity.

The occupant control module 62 uses a vehicle model to predict the occupant position through initial seat position and belt payout status. It further uses the real-time seat belt force as a chest acceleration sensor input for the real-time control algorithm 14. In this case, the level and rate of change of the belt force infers the chest acceleration. The belt force is then used in the control algorithm and real-time adjustments are then made accordingly. The occupant control module 62 recursively uses the predicted or measured occupant restraint factors 22 to control occupant restraint performance, and further allows for the development of a real-time vehicle restraint system 18.

In this regard, the occupant control module 62 optionally can set configure restraint system to use the real-time air bag pressure as a head acceleration sensor input for the real-time control algorithm 14. For example, the level of air bag pressure infers the head acceleration. The air bag pressure is then used in the control algorithm and real-time adjustments are then made accordingly. The air bag pressure is measured using sensors placed within the air bag module housing.

The occupant control module 62 additionally is further configured to set the parameters/variables of the restraint system to adjust the belt stiffness once a desired chest acceleration and/or belt load threshold is exceeded maximizing the ride down space while minimizing the chest and head injury. The belt stiffness is continuously adjusted real-time after a threshold condition has been reached. If the chest acceleration increases above the threshold condition, the stiffness of the belt is reduced. If the belt force falls below the threshold, the belt force is increased. With this method, the chest G injury is minimized and the ride down space within the vehicle is utilized to a maximum. The restraint system controls the maximum seat belt load limiter displacement or belt payout minimizing potential of contact with injurious surfaces. It is possible, in a severe crash condition with limited ride down space, the occupant could make contact with the interior.

To reduce the probability of contact, the belt payout and/or load limiter displacement is monitored and controlled. Based on vehicle interior space defined in the model, the maximum load limiter displacement is set. The maximum load limiter displacement is dependent upon the initial payout condition and position of the seat. A sensor mounted in the retractor monitors the pay out of the belt, and the control system in conjunction with the seat position data, would decide if the occupant were at risk of contacting the interior. Examples of this can be found in commonly assigned U.S. Pat. No. 6,598,821; U.S. Pat. No. 6,439,494, and U.S. patent application Ser. No. 10/135,566, herein incorporated by reference.

By controlling the amount of force F applied through the retractor, a controllable loading force can be applied on the chest and, therefore, achieve a constant occupant G loading. The magnitude of the seat belt retractor force is determined by the control system and algorithm based off occupant, restraint, and vehicle condition inputs. Sensors are used to monitor the vehicle crash condition and occupant accelerations either directly (acceleration sensors) or indirectly (seat belt load). The control algorithm then determines if the seat belt should increase or decreases its tension. An electronically controlled retractor produces the adjustment of the belt tension force.

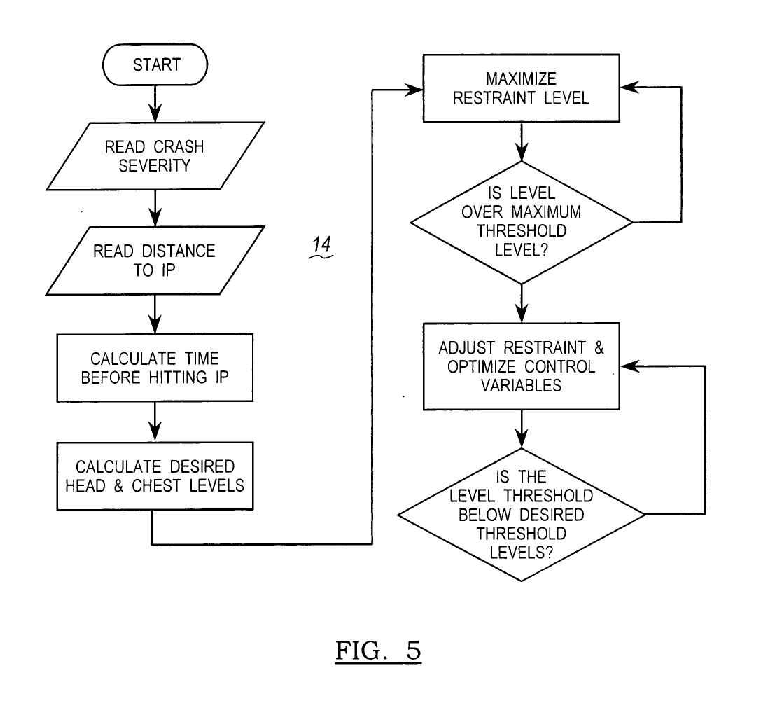

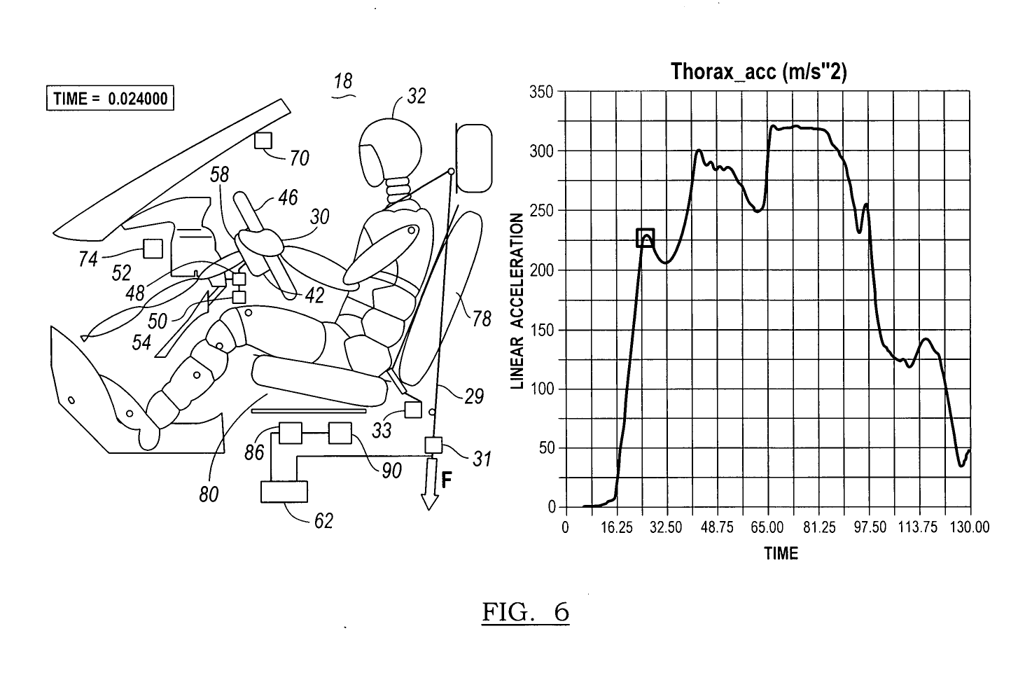

As seen in FIG. 6, at crash onset the retractor applies a pre-tensioning force followed by an adjustable load limiting function as the crash evolves. The following graph shows the simulated motion of the retractor resulting from applying the pre-tensioning force. The control of the force F applied by the retractor is completed within the occupant control module 62. Based on the threshold settings within the occupant control module 62, the force applied by the retractor is then varied to maintain a constant occupant acceleration level during the crash event. The occupant acceleration and retractor load setting is continuously monitored and adjusted. In this scenario, the seatbelt force from the retractor can be increased or decreased (bi-directional).

An alternative way of achieving the constant real-time G seat belt retractor is done by controlling the release of the seat belt. This type of control would allow the retractor to pay out seat belt webbing. This approach removes an oscillation problem found in the previous type of control. A way of achieving this type of control is to adjust the friction force applied to a rotary brake device responsible for the rotary position of the seatbelt retractor spool.

Additionally, the occupant control module 62 optionally allows the restraint system 18 to utilize occupant proximity sensing systems and data to control the seat belt load and displacement performance in real-time. In addition to monitoring the belt payout and load limiter displacement, the proximity of the head and chest is monitored through a proximity sensing system and the data is fed back to the restraint control algorithm 14. For example, if the head and chest are too close to a contact surface, the seat belt and air bag are stiffened to minimize contact potential. It is envisioned this tightening can be accomplished using pretensioner or appropriate actuators coupled to the retractor. It is envisioned that the occupant control module 62 can develop independent control algorithms (driver and passenger) for the occupant's restraint system 18 based on independent sensor inputs and real-time deceleration data.

During an offset type crash condition, the impact energy seen by each frontal occupant can vary with seat position. The occupant control module 62 allows the development of a real-time control device to provide the appropriate restraint to each occupant dependent upon the related impact conditions as seen by that occupant. The occupant control module 62 allows for the adjustment of the restraint performance to be tailored to unique real world events of the specific crash. Real-time controls adjust the restraint system 18 to control the head and chest accelerations to pre-defined threshold levels. If the levels are exceeded, the restraint systems changes appropriately. In this way, the restraint control is directly matched to the actual crash and provides a unique restraint control for each specific crash.

The control module 62 predicts the occupant position through initial seat position and belt payout status. The control module 62 then uses the real-time seat belt force as a chest acceleration sensor input for the real-time control algorithm. In this case, the level of belt force infers the chest acceleration. The belt force is then used in the control algorithm 14 and real-time adjustments are then made accordingly. The control module 62 uses the real-time air bag pressure as a head acceleration sensor input for the real-time control algorithm. In this case, the level of air bag pressure infers the head acceleration. The air bag pressure is then used in the control algorithm 14 and real-time adjustments are then made accordingly. The system adjusts the belt stiffness once a desired chest acceleration and/or belt load threshold is exceeded maximizing the ride down space while minimizing the chest and head injury.

The occupant control module 62 allows for the development of a restraint control to be applied to multiple impacts through real-time control of restraint parameters. The real-time control of the restraint system allows for monitoring the occupant performance and can, therefore, be used in multiple impact conditions. In the case of the seat belt system, the first impact may not be severe and the belt force is controlled accordingly. The second or later impact may then be severe and an appropriate restraint level is supplied based on the new impact and occupant conditions, subsequently providing the appropriate restraint over a series of impacts. As a result, the opportunity to provide improved restraint over a range of conditions increases.

The system allows the use of a standard air bag across multiple platforms with the occupant performance for each platform tailored through active seat belt load limiter control and active air bag venting using the control algorithm 14. Air bag systems are traditionally developed for a specific platform to meet performance requirements, incurring significant test and development costs. In addition, DV and PV's have to be completed for each unique design. In a system where the air bag performance is controlled through an algorithm the system allows the potential of a single air bag design to be used and applied. This is a similar to the methods used by electronic suppliers for sensing diagnostic modules (SDM's). One SDM is manufactured and the control algorithm is developed to suit the specific vehicle application. This methodology allows the use of an analog restraint control detection algorithm. That is, an algorithm that predicts the delta velocity in an analog fashion rather than the current discrete predictions.

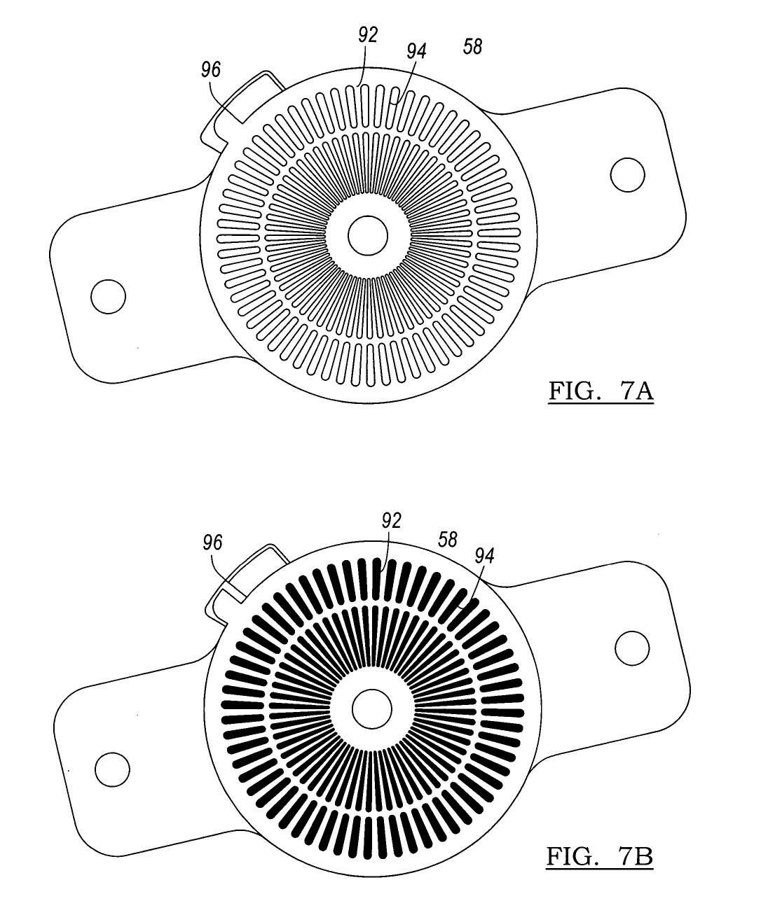

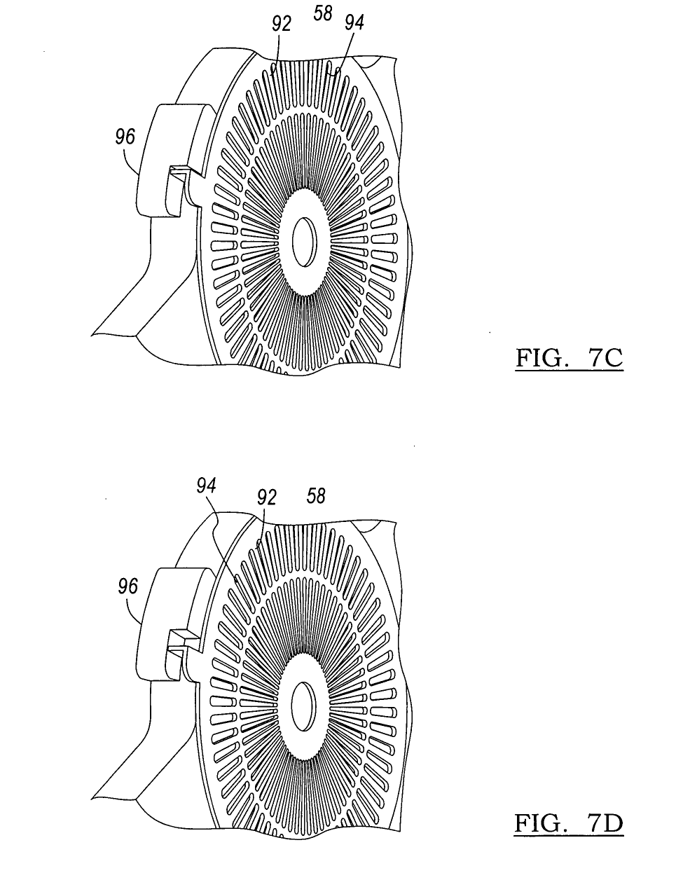

FIGS. 7a-7d depict an example of a venting mechanism that can be switched from a fully open position to a fully closed position with a rotation of only 3 degrees. The system 10 functions to control venting of the air bag housing using Pulse Width Modulation (PWM) digital control of an air bag venting valve. Analog/digital control of air bag venting is completed through forced displacement of module gases rather than venting across the bag and ambient pressure conditions (passive).

The venting mechanism has a first circular plate 92 having a plurality of radially disposed slots 94. The plate is rotationally mounted to a base portion which has a corresponding set of radially disposed slots. Disposed on the base member is an actuator 96 which is configured to rotate the circular plate at frequencies of up to about 500 Hertz. In this regard, the actuator allows the circular plate to rotate less than 5 degrees and preferably about 3 degrees to effectuate the complete closing and opening of the valve. It is envisioned that the system can vary the frequency of the actuator so as to cause the circular plate to rotate and, thereby, cause the valve to have an effective venting area. By modifying this effective venting value, the controller can in real-time, using a digital signal, vary the response of the air bag system. Although the vent is shown as a rotatably oriented plate, it is equally envisioned that the plate can have a rectangular cross-section which is configured to be open and closed at speeds of up to about 500 Hertz by lateral translation.

In the case where the air bag vent is open and closed rapidly (500 hz), the gas mass flow moving through the vent based on local pressure difference would be affected by the action of the vent opening and closing. Shock waves and the time to build the pressure difference across the vent could produce a very inefficient vent performance. Therefore, the use of a positive displacement pump that forces the gas to leave (gas is pumped out of the bag) bag could be more effective. The control system would indicate when air venting was required and then engage the positive displacement device for the desired length of time.

From the foregoing, it can be seen that a system and methodology for accurately determining occupant presence and position for a vehicle safety restraint system is provided. This system may be used to control the dynamic performance of various safety restraint components in the vehicle so that the actions of these safety restraint components may be tailored or matched to the occupant's seating position and severity of an accident, thereby maximizing passenger protection in a vehicle collision.

The description of the invention is merely exemplary in nature and, thus, variations that do not depart from the gist of the invention are intended to be within the scope of the invention. Such variations are not to be regarded as a departure from the spirit and scope of the invention.

1. A system for controlling the design of a safety restraint system so that a predetermined desired level of an occupant's response is produced, the controller comprising:
a multi-domain occupant restraint factor response model, the model interrelating at least one predetermined restraint configuration with the occupant response, the restraint configuration having a first set off variable restraint control parameters which are indicative of an first set of adjustable control values of at least one component of a safety restraint system, said model being configured to simulate a crash event by conducting a series of calculations which describe the event over a discrete time domain;
a solver module configured to receive data from the occupant restraint factor response model at a predetermined interval which is coupled to the occupant restraint model so as to generates a second set of restraint control parameters which are indicative of an second set of adjustable control values that are then passed back to multi-domain restraint simulation code; and
whereby the safety restraint design is controlled based upon the determined second level of the restraint factors which produces the desired level of the safety response.

2. The safety restraint design controller of claim 1 wherein the solver utilizes an optimizer connected to the database engine for determining the second level of the restraint factors which produces the desired level of the occupant response based upon the desired level of the occupant response from the database engine.

3. The safety restraint design controller of claim 1 wherein the model interrelates a plurality of variable restraint factors with a plurality of occupant responses.

4. The safety restraint design controller of claim 1 wherein the optimizer constrains the permissible level ranges for the restraint factors and for the occupant responses in determining a second level of the occupant restraint factors.

5. The safety restraint design controller of claim 1 further including a computer-human interface for constraining the permissible level ranges for the restraint factors and for the occupant responses in determining a second level of the occupant responses.

6. The safety restraint design controller of claim 1 further containing a coupling module coupling the solver module to the multi-domain restrain response model.

7. The safety restraint design controller of claim 1 wherein the optimizer constrains the permissible level ranges for the restraint factors and for the occupant responses in determining a second level of the occupant restraint factors.

8. A computer implemented method for designing a safety restraint system so that a predetermined desired level of occupant responses produced, comprising the steps of:
storing an occupant restraint factor response model in a computer storage medium, the model interrelating at least one predetermined restraint factor with the occupant response, the restraint factors having a level which is indicative of setting values for response output for components within the design of the restraint system;
determining a level for the occupant response based upon the model and upon a first level of the restraint factors;
determining a second level of the restraint factors which produces the desired level of the occupant response based upon the determined level of the occupant response;
providing a solver configured to receive signals from the occupant response model and determining if changes should be made to the response factors are needed; and
a coupling software operatively disposed between the solver and the occupant restraint response model.

9. The computer implemented method for designing a safety restraint system of claim 8 wherein the model of the model includes interrelating a plurality of restraint factors with a plurality of occupant responses.

10. The method for designing a safety restraint system according to claim 8 further comprising coupling a sensor's output to the solver.

11. The method for designing a safety restraining system according to claim 10 wherein the sensor's output is simulated.

12. An occupant sensing apparatus for controlling operating characteristics of a vehicle's safety restraint system, comprising:
a first sensor emitting a first signal indicative of an occupant being within a distance of a location within the vehicle;
a controller receiving the first output signal and generating a control signal that is used to vary the operating characteristics of the vehicle's safety restraint system more than once within a first predetermined time frame of a crash event; and
a means for changing the operating characteristic of the restraint system in response to a signal provided by the controller.

13. The apparatus as described in claim 12 wherein the first predetermined time frame is less than 300 msec.

14. The apparatus as described in claim 13 wherein the means for varying the characteristic of the restraint system is a variable vent.

15. The apparatus as described in claim 13 wherein the means for varying the characteristic of the restraint system is a variable output air bag.

16. The apparatus as described in claim 13 wherein the means for varying the characteristic of the restraint system is a variable load retractor.

17. The apparatus as described in claim 12 wherein the sensor is an occupant proximity sensor.

18. The apparatus as described in claim 12 wherein the sensor is coupled to the retractor.

19. The apparatus as described in claim 12 wherein the controller is an open loop controller.

20. A method of changing the output of a restraint system based upon the location of an occupant within a vehicle environment comprising the steps of:
a) providing a first sensor which produces a first signal indicative of an occupant's location within the vehicle;
b) providing a means for changing the output of the restraint system;
c) providing an open loop controller for controlling a operating characteristics of a vehicle safety restraint system;
d) calculating the location of the occupant within the vehicle; and
e) providing the first minimum distance information to the controller.

21. The method as described in claim 20, further comprising the step of:
f) changing the output of the restraint system a first time.

22. The method as described in claim 21, further comprising the steps of:
g) calculating a first optimum squib fire time;
h) providing an electrical current to a first squib; and
i) providing an electrical current to a second squib.

23. The method as described in claim 20 further comprising the step of:
j) changing the output of the restraint system a second time within a predetermined amount of time.

24. The method according to claim 22 wherein the predetermined amount of time is less than 300 msec.

25. The method as described in claim 20 further comprising the steps of:
k) calculating an optimum effective vent value; and
I) providing an alternating current to a variable vent at a predetermined frequency so as to cause the vent to have the effective vent value.

26. A vent for an air bag housing comprising:
a first member configured to be rotated about a pivot point, the first member defining a first plurality of radially positioned apertures; and
a drive mechanism configured to cyclically rotate the first member from a first position to a second position, wherein the first plurality of radially positioned apertures are aligned with a second plurality of radially positioned apertures that are fluidly coupled to a cavity defined by the housing.

27. The vent according to according to claim 26 wherein the drive mechanism is configured to rotate the first member at a predetermined frequency less than 50 hz.

28. The vent according to claim 26 wherein the first plurality of radially positioned apertures is a plurality of slots.

29. The vent according to claim 26 wherein the drive mechanism is configured to rotate the first member less than 5 degrees.

30. A vent for an air bag housing comprising:
a first member defining a first plurality of slots;
a second member defining a second plurality of slots; and
a drive mechanism configured to translate the first member with respect to the second member to align the first plurality of slots with the second plurality of slots.

31. The vent according to claim 30 wherein the first member is rotatably coupled to the second member.

32. The vent according to claim 30 wherein the drive mechanism is configured to translate the first member from a first position to a second position and back to the first position at a predetermined frequency.
